(19) United States
(12) Patent Application Publication
(10) Pub. No.: US 2004/0081581 A1
(43) Pub. Date: Apr. 29, 2004

(54) Urine specimen cup toxicology indicator cap

(76) Inventors: Robert A. Mount, Santa Rosa, CA (US); Wayne B. Ross, Santa Rosa, CA (US)

Correspondence Address: JOHNSON & STAINBROOK, LLP, Suite 203, 3550 Round Barn Blvd., Santa Rosa, CA, 95403, US

(21) Appl. No.: 10/679,624

(22) Filed: Oct. 6, 2003

Related U.S. Application Data
(60) Provisional application No. 60/420,987, filed on Oct. 24, 2002.

(51) Int. Cl. G01N 31/22; G01N 21/64

(52) U.S. Cl. 422/61; 422/58

(57) ABSTRACT

A urine specimen cup toxicology indicator cap having a transparent top surface and bottom surface forming a testing cavity, wherein a plurality of reagent test strips, each of which having a reading zone where reactions may be observed, are mounted in a parallel fashion on channels within the test cavity. Fluid contained in a specimen cup, which is attached to the toxicology indicator cap in a fluid tight fashion, may be introduced to the reagent test strips within the test cavity through an aperture in the bottom surface of the toxicology indicator cap when the specimen cup is inverted. Fluid access is to the reagent test strips is controlled by an absorbent material within the aperture which is in contact with the reagent test strips. Returning the specimen cup and toxicology indicator cap to an upright position allows fluid to wick from the absorbent material onto the reagent test strips where reagent-analyte reactions may be observed.

### CROSS REFERENCE TO RELATED APPLICATIONS

The present application claims the benefit of the filing date of U.S. Provisional/Utility Patent Application, Ser. No. 60/420,987, filed Oct. 24, 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to toxicology screening devices, more particularly to a toxicology indicator cap containing an array of toxicological indicator strips for the detection of drugs or other chemicals present in a container for holding a fluid sample.

### BACKGROUND INFORMATION AND DISCUSSION OF RELATED ART

Screening of fluids for pharmaceutical and chemical substances is in great demand. Employers often require the screening of employment applicants for drugs of abuse (DOA) and athletes are often screened for performance enhancing drugs. Generally, this type of testing occurs in two phases: the initial screen and the confirmatory test. The initial screen is usually performed on a fluid such as urine, which is easily collected without invasive procedures. A positive test at the screening stage would require the sample to be forwarded to a laboratory for more rigorous and complete testing to verify the results of the screening test. Thin layer chromatography (TLC) is a traditional method of screening for non-protein substances. This system utilizes the differential mobility of a compound in a mobile phase through a stationary phase such as silica bound to a glass or plastic plate. The differential mobility of the compound, in combination with staining characteristics in the presence of developing compounds such as furfurol or ninhydrin, or absorbency in UV or visible light, give tentative identification of compounds when compared to a reference preparation of a compound. Although this method is well characterized, it does require sample preparation and interpretive skill. Other screen tests are based on binding of specific antigens to antibody complexes. These immunologically based tests offer a wide variety of application methods and simplify interpretation of screening results. The large volume of drug and chemical screening being done worldwide demands a simple, convenient and accurate screening phase in order to steam line the process. In the on-site drug testing industry, several standards have emerged. Urine collection containers are fairly uniform in size, in both diameter and depth. Toxicology test strips housed in testing cassettes are also generally uniform, such uniformity having mainly to do with the surface area necessary for effective testing and the distance drugs must migrate to distinguish a positive from a negative result. Furthermore, most companies prefer multi-test indicators providing testing for five different drugs—typically, cannabis or THC, opiates, cocaine, amphetamines, and PCP, though several other tests and combinations are possible. The drug testing indicators are typically housed in rectangular cassettes that are dipped into a specimen cup or are otherwise exposed to a urine sample.

It is known to combine specimen cups with chemical test strips to eliminate the need to dip a test cassette into a volume of body fluids to effect a test. For instance, U.S. Pat. No. 5,595,187 to Davis discloses a lid for an analytical specimen cup system having outer and inner partitions defining a test space in which a chemical test strip is mounted with the inner partition defining: a raised test-strip holder on which the chemical test strip is mounted, a lower sump having a floor position substantially below the raised test-strip holder for receiving and retaining test fluid which drains downwardly from the raised test-strip holder, and an opening-defining member for selectively defining an opening for allowing test fluid to be transferred from a cup interior space into the test space but not allowing it to return to the cup interior space.

U.S. Pat. No. 5,238,652 teaches a device for specifically testing for the presence of non-protein antigens such as most drugs of abuse. This device utilizes a thin layer chromatography membrane for testing for the presence of certain drugs of abuse. The assaying device taught makes use of colored latex spheres combined with a specific antibody for binding to a specific antigen (i.e. drug). The latex spheres are applied to a chromatography membrane upstream of an immobilized drug conjugate probe. The antibody/latex complex is picked up by the test liquid and is used to indicate the presence or absence of a specific antigen drug. A positive test is indicated by the absence of a colored line in the area of the drug conjugate probe on the chromatography membrane. In use, urine drops are withdrawn manually from a collection vial and added drop-wise to a reception cavity on the device. The urine is then absorbed by a pad and moves along the chromatography membrane by capillary action.

U.S. Pat. No. 5,403,551 to Galloway teaches an assaying device for both collecting and analyzing a sample. The device includes a container and an opening for collecting the sample in a chamber for storing the sample. A cap is provided for sealing the container opening and at least one assay system is attached to the container for chemically analyzing the sample. A channel is provided for enabling a portion of the sample to enter the assay system upon a change of orientation of the container. In this system, the chemical test strips are vertically disposed and fluid is introduced into a channel immediately above the strips when the container is tipped.

U.S. Pat. Nos. 5,429,804 and 5,501,837 to Sayles each show a specimen cup toxicology indicator combination including a cup, a cover lid, a chamber disposed beneath the lid, and a plurality of reagent membrane strips arrayed within the chamber. The reagent strips extend through notches formed in the side wall of the chamber and protrude into an area where they can come in contact with the fluid to be tested beneath the cover lid when the cup is inverted. The reagent strips are visible through a transparent top in the cover lid. In use, when the fluid specimen is placed within the specimen cup and the lid is affixed in fluid-tight relationship by screw threads, the specimen cup is inverted, allowing the fluid to be tested to come in contact with the ends of each reagent strip. In one embodiment the reagent strips protrude beyond the chamber side wall beneath the cover lid; in another, each reagent strip is disposed within its own chamber segment within the chamber and terminates in a dedicated well. The fluid is drawn along each reagent strip by capillary action until the fluid comes to the bands of the chromatographic immunoassay test reagent where a color change can occur when each strip reacts with the fluid to perform the desired test. The transparent top of the lid allows each reagent strip to be observed for color change reactions, and labels around the rim at the top of the lid disclose which reagent strip is performing which test in its associated chamber segment.

U.S. Pat. No. 5,922,615 to Biosite Diagnostics, Inc., teaches a porous member having at least one binding agent in communication with a textured non absorbent member having at least one capillary to facilitate the movement of fluid into the porous member. The capillary action controls the amount of fluid deposited on the porous membrane and the rate of deposition of the fluid onto the porous membrane. The porous membrane facilitates the movement of fluid a reagent strip.

Of the foregoing patents, none teach or disclose a combination specimen cup and cap wherein the cap includes a single absorbent pad with which an array of reagent strips comes into contact for introducing a fluid specimen into the indicator strips. The device describe herein provides a simplified approach to collection, and chemical detection by eliminating manual introduction of sample fluid, incorporation of valves, collection chambers or capillary beds to introduce fluid to the target assay reagent strips. The elimination of mechanical manipulation, introduction or entrapment of the sample fluid reduces assay errors introduced by either sample contamination or by failure of a manufactured portion of the device designed to meter, introduce or control the rate of uptake of a fluid sample.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is a device having a threaded toxicology indicator cap for testing fluids for drugs or chemicals. The device has an absorbent pad for capturing and introducing fluid samples to test chamber located in the toxicology indicator cap. The absorbent pad acts as a barrier to the uncontrolled introduction of fluid into the test area. Fluid is introduced onto the absorbent pad by a inverting of the cup. The assay portion of the device consists of at least one and generally a plurality of reagent toxicology indicator strips held within a test chamber within the cap. The results of the test are visible through a clear window on the top of the cap.

It is therefore an object of the present invention to provide a new and improved toxicology indicator cap which provides a simplified sample introduction apparatus.

It is another object of the present invention to provide a new and improved toxicology indicator cap that allows easy photocopying of test results with minimal leakage.

A further object or feature of the present invention is a new and improved toxicology indicator cap that eliminates the need for entering the container to aliquot samples for toxicology testing, thus limiting the possibility of tampering or contamination.

It is yet another object of the present invention to provide a toxicology indicator cap that eliminates the need for a large volume of fluid sample to produce an effective indication of the presence of drugs and/or their metabolites.

It is still a further object of the present invention to provide a toxicology indicator cap with flexibility in the test panels that may be employed for a given fluid sample.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a perspective view of a preferred embodiment of the toxicology indicator cap of this invention;

FIG. 2 is a top view of the toxicology indicator cap of FIG. 1;

FIG. 3 is a bottom view of the toxicology indicator cap from FIG. 1 and FIG. 2 showing the volume limiting absorbent zone;

FIG. 4 is a cross sectional side view of the toxicology indicator cap from FIG. 1, FIG. 2 and FIG. 3;

FIG. 5 is a perspective view of a second embodiment of the toxicology indicator cap in combination with a cup body;

FIG. 6 is an exploded view of the second embodiment of the toxicology indicator cap in combination with a cup body; and

FIG. 7 is a side view of the cup body in a stacked configuration of four cup bodies.

### DRAWING REFERENCE NUMERALS

100 first preferred embodiment of inventive toxicology indicator cap (generally)

110 threaded base member

120 channels in base member top surface

130 top surface of base member

140 reagent test strips

150 aperture defining a volume limiting absorbent zone

160 absorbent material in contact with aperture

170 reading zone where reactions may be read

180 strip absorbent pad

200 second preferred embodiment of present invention

260 reagent strip holder

210 cup body

215 temperature indicator strip

220 over cap

230 transparent top

240 tab (extending from the bottom surface of the face of the over cap)

250 tab slot

270 label

260 reagent test strip holder

280 reagent test strips

290 O ring of silica gel

300 channels for holding reagent test strips

310 aperture on bottom surface of reagent strip holder

320 thin absorbent material

330 filter paper strips

340 glass fiber strip

350 thick absorbent material

360 polyethylene O ring

### DETAILED DESCRIPTION OF THE INVENTION

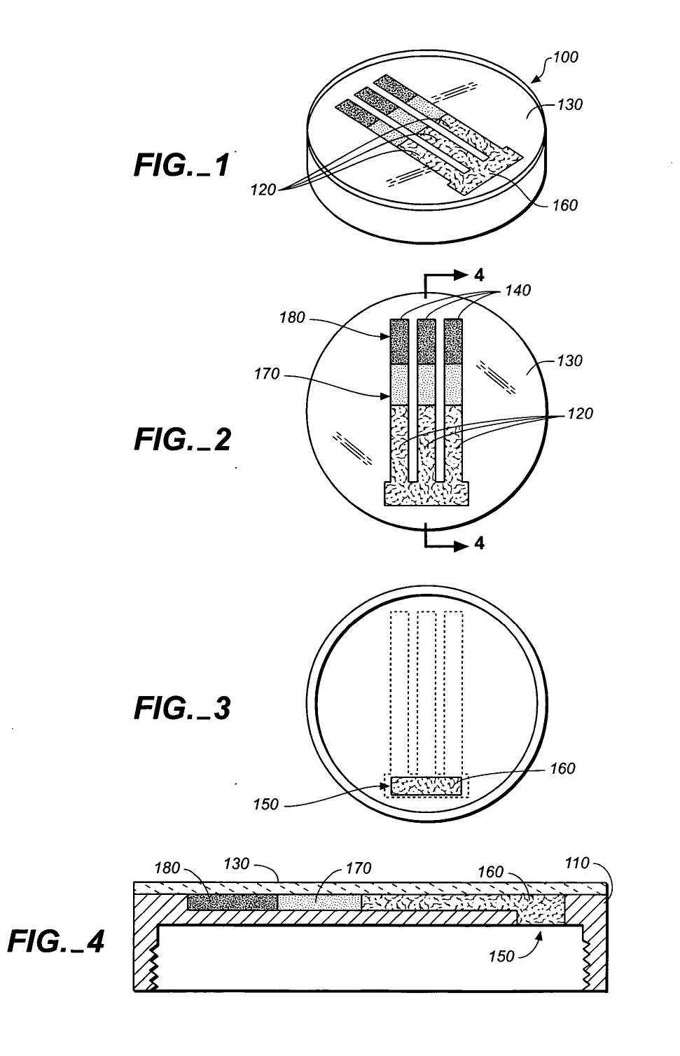

Referring to FIGS. 1 through 7, wherein like reference numerals refer to like components in the various views, there is illustrated therein a new and improved toxicology indicator cap, generally denominated 100 for a first preferred embodiment and 200 for a second preferred embodiment herein.

FIG. 1 illustrates a perspective view of a first preferred embodiment of a threaded cylindrical toxicology indicator cap 100. FIG. 2 and FIG. 3 illustrate top and bottom views of the toxicology indicator cap, respectively. FIG. 4 is a cross sectional side view of the toxicology indicator cap. The views collectively show a cylindrical toxicology indicator cap 100 comprising a threaded base member 110 having a plurality of slots or channels 120 into its top surface 130 for holding reagent test strips 140 having a first and second end. The threaded base further includes an aperture 150 defining a volume limiting absorbent zone having absorbent material 160 which is in communication with the first end of each of the reagent test strips 140, comprising a reading zone 170 where reactions may be read. A strip absorbent pad 180 is in communication with the second end of each reagent test strip.

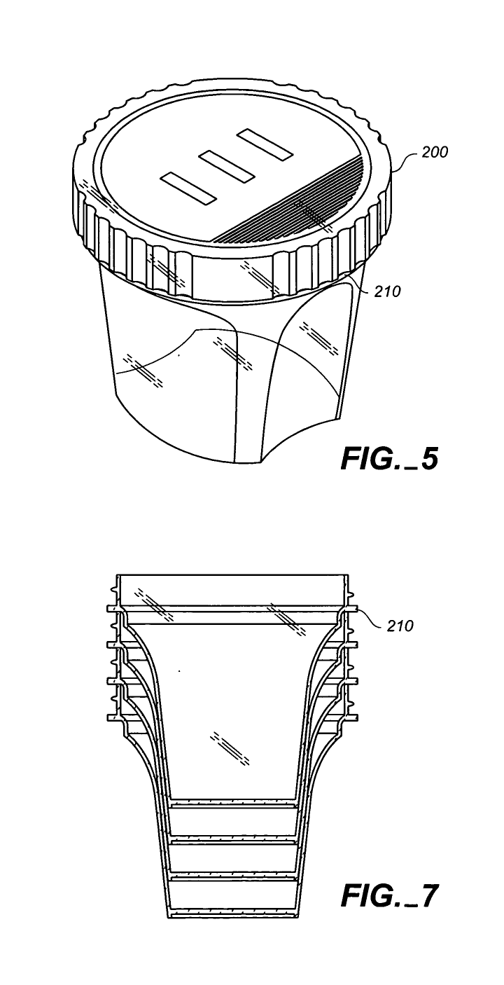

FIG. 5 is a perspective view of a second preferred embodiment of the present invention comprising a toxicology indicator cap 200 and a cup body 210.

FIG. 7 is a side view of the cup body 210 formed by a tapered, generally cylindrical shape with a closed end and an open end for holding a fluid. The open end is threaded to accept the threaded toxicology indicator cap. The tapered shape of the cup body allows for the stacking of the cup bodies for storage purposes.

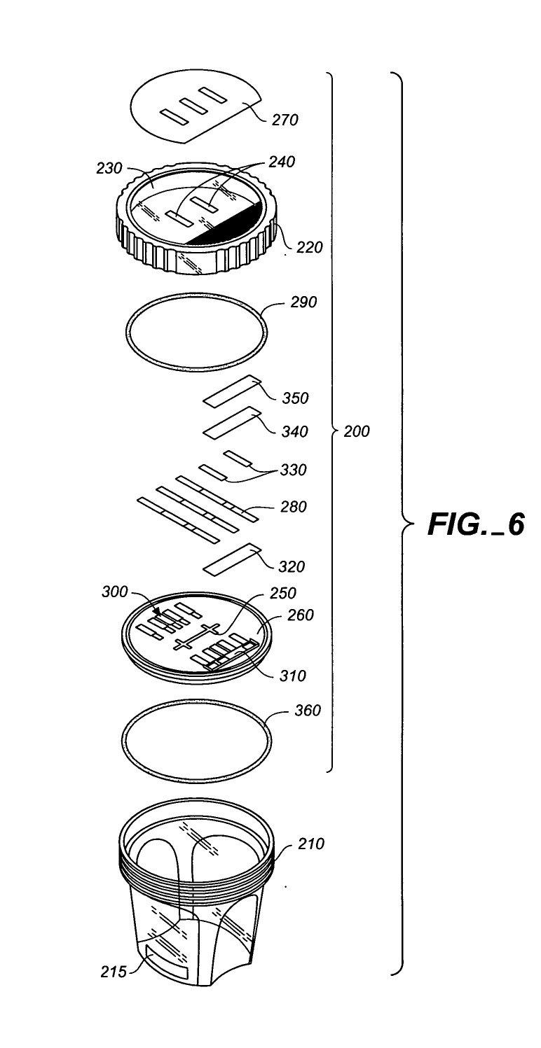

FIG. 6 is an exploded view of the second preferred embodiment of the toxicology indicator cap 200 and the cup body 210. Attached to the cup body is a temperature indicator strip 215 which indicates the temperature of a fluid specimen such as urine when collected in the cup body. The toxicology indicator cap comprises a cylindrical, threaded over cap 220 with a transparent top 230. The bottom surface of the over cap has at least one tab 240 extending in a perpendicular plane from the bottom surface of the face of the over cap which are accepted into a tab slot 250 of corresponding dimensions located on the upper surface of a disk shaped reagent test strip holder 260. A label 270 with rectangular cut outs is applied to the transparent top of the over cap. The label allows viewing of the reactions on reagent test strips 280, which have a first and second end. An “O” ring 290 made of silica gel or a related pliable synthetic material capable maintaining a fluid resistant barrier seal between the over cap and the disc shaped reagent strip holder is inserted a groove in top perimeter of the reagent test strip holder, creating a testing cavity between the over cap and the reagent test strip holder for performing an assay. The disc shaped reagent test strip holder has a plurality of slots or channels 300 in its top surface to hold a plurality of reagent test strips. The disc shaped strip holder further includes an aperture 310 on its bottom surface whereby fluid is introduced to a thin absorbent material 320 constructed of filter paper or another absorbent cellulose material held on the top surface of the disc shaped reagent test strip holder in communication with the aperture. The thin absorbent material is in communication with the first end of the reagent test strips at a ninety degree orientation. Each reagent test strip is in further communication on the top surface of their first end, with filter paper strips 330 of rectangular shape, oriented in the same rotational plane as the reagent test strips. The filter paper strips are in contact on their top surface with a glass fiber strip 340 oriented at ninety degrees to the filter paper strips. A thick absorbent material 350, constructed of filter paper or another absorbent cellulose material, is in contact with the top surface of the glass fiber strip and is oriented in the same rotational plane as the glass fiber strip. The thin absorbent material, filter paper strips, glass fiber strip and the thick absorbent material combine to control the introduction of fluid onto the reagent test strips within the cavity formed by the over cap and the disk shaped reagent strip holder. The reagent strip holder further includes a Polyethylene “O” ring 360 which provides a fluid tight seal when in contact with the threaded cup body.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A urine specimen cup toxicology indicator cap, comprising:
a toxicology indicator cap having attachment means for attachment to a specimen cup and to provide a fluid tight cover for the specimen cup, and further having a transparent top surface and a bottom surface defining a test cavity therebetween, said bottom surface having an aperture placing said test cavity into fluid communication with fluid contained within the specimen cup, said test cavity including at least one channel for holding at least one reagent test strip;
at least one reagent test strip positioned within each of said channels in said test cavity, each of said reagent test strips having a first end, a reading zone for test color development, and a second end; and
a strip absorbent pad disposed in test cavity and generally filling the aperture in said bottom surface, said strip absorbent pad providing fluid communication to said first end of said reagent test strips, wherein said strip absorbent pad controls the introduction of fluid from said specimen cup into said test cavity when the specimen cup is inverted and the contained fluid contacts said strip absorbent pad, and wherein after said apparatus receives a fluid sample in said test cavity, reactions in said reading zone of said reagent strips may be observed through said transparent top surface.

2. The apparatus of claim 1, wherein said transparent top surface includes a label having at least one cut out area positioned for viewing and photocopying said color development areas on said reagent test strips.

3. The apparatus of claim 2, wherein said label includes instructions for use, and a chart defining positive, negative and invalid test reactions.

4. The apparatus of claim 1, wherein said transparent top surface is formed by an over cap.

5. The apparatus of claim 1, wherein said channels for holding reagent test strips are integral with said bottom surface.

6. The apparatus of claim 1, wherein said channels in said test cavity are aligned in a generally parallel manner.

7. The apparatus of claim 1, wherein said channels in said test cavity are positioned in a radial manner.

8. The apparatus of claim 1, wherein said reagent test strips are in further contact on said first end with absorbent strips which enable a fluid sample to wick onto said reagent test strips.

9. The absorbent strips of claim 8, wherein said absorbent strips are in contact with a glass fiber strip.

10. The glass fiber strip of claim 9, wherein said glass fiber strip is in contact with a thick absorbent material.

11. The apparatus of claim 1, wherein said strip absorbent pad is in contact with a plurality of layers of further absorbent material to prevent the introduction of an excess of said fluid into said test cavity.

12. A method of introducing a fluid sample in a controlled manner onto reagent test strips contained within the toxicology indicator cap of claim 1, comprising the steps of:
(a) collecting a fluid specimen in a specimen cup and attaching the toxicology indicator cap to the specimen cup in a substantially fluid tight manner;
(b) inverting the specimen cup to expose the fluid specimen to the aperture in the bottom surface of the toxicology indicator cap; and
(c) returning the specimen cup to an upright position to allow the fluid to wick into the strip absorbent pad in contact with the aperture, thus exposing the reagent test strips in contact with the strip absorbent pad to the fluid.

13. A method of controlling fluid ingress into the test cavity contained within the toxicology indicator cap of claim 1, said method comprising the steps of:
(a) collecting a fluid specimen within a specimen cup adapted for attachment to the toxicology indicator cap;
(b) layering absorbent materials within the test cavity of the toxicology indicator cap, with at least one absorbent material in communication with the aperture in the bottom surface of the toxicology indicator cap, thereby providing wicking of fluid in a controlled manner into the test cavity contained within the toxicology indicator cap;
(c) attaching the toxicology indicator cap to the specimen cup in a substantially fluid tight manner; and
(d) inverting the specimen cup to allow fluid specimen to flood the aperture in the bottom surface of the toxicology indicator cap.
